(19) United States
(12) Patent Application Publication
(10) Pub. No.: US 2014/0068591 A1
(43) Pub. Date: Mar. 6, 2014

(54) Monitoring Software

(71) Applicants: Dave Harding, London (GB); Geoff Collins, Epsom (GB); Shaun Cassells, Cedar Rapids, IA (US)

(72) Inventors: Dave Harding, London (GB); Geoff Collins, Epsom (GB); Shaun Cassells, Cedar Rapids, IA (US)

(73) Assignee: 1E LIMITED, London (GB)

(21) Appl. No.: 13/598,226

(22) Filed: Aug. 29, 2012

(51) Int. Cl. G06F 9/445

(52) U.S. Cl. CPC G06F 8/61; G06F 8/62
USPC 717/171

(57) ABSTRACT

A networked computer system comprises a source of usage data relating to usage of software installed on respective computers of the system, and a source of attribute data relating to attributes associated with the computers. A usage engine evaluates usage of the installed software based on the usage data. A mapping engine selects a mapping rule associated with the installed software in dependence on the evaluated usage data and the attribute data and provides an action to take in relation to an item of software in accordance with the selected rule. The action comprises, for at least some installed software, replacement of the software by alternative software selected by the rule.

### TECHNICAL FIELD

The present invention relates to a method of, and system for, monitoring usage of software on computers in a computer network.

### BACKGROUND

Monitoring and upgrading software installed in computing devices in a network is known. In one system, the usage of installed software is measured and a determination is made whether or not to upgrade a software package based on the measure of usage.

### SUMMARY

In accordance with one aspect of the present invention, there is provided a networked computer system comprising:
a source of usage data relating to usage of software installed on respective computers of the system,
a source of attribute data relating to attributes associated with the computers, a usage engine which evaluates usage of the installed software based on the usage data,
a mapping engine arranged to select a mapping rule associated with the installed software in dependence on the evaluated usage data and the attribute data and to provide an action to take in accordance with the selected rule.

In some embodiments the action comprises, for at least some installed software, replacement of the software by alternative software.

In some embodiments the mapping engine provides mapping rules which provide different actions for respective computers.

The attribute data allows software to be replaced according to the attributes of the computer. The attribute data may also include data relating to the user of the computer. For example if the attribute data indicates the computer is used by an accountant in an accounts department and a particular accounts package is heavily used, data is produced according to the rule identifying upgraded software, e.g. the latest version of data is produced indicating it should be replaced by an alternative software more appropriate to the user. If a computer in some other department has the same software which is rarely used or not used, the data may indicate that the software should be uninstalled or replaced by alternative less powerful software. The replacement of the software may take place automatically.

Different rules may be provided for the same software in different computers according to the attributes.

The system allows software to be monitored and upgraded, with unused software un-installed, and rarely used software replaced by alternative more suitable software or un-installed but taking account of operational requirements as defined by the attributes and rules. This improves the reliability of the network by removing unused software and by standardising software, which is used, to the latest version.

Another aspect of the invention provides a non-transitory computer readable medium storing instructions which, when executed by a processor arranged to receive, from a source of usage data, data relating to usage of software installed on respective computers of the system, and to receive, from a source of attribute data, data relating to attributes associated with the computers, causes the processor to perform a computer implemented method comprising:
evaluating usage of the installed software based on the usage data, and
selecting a mapping rule associated with the installed software in dependence on the evaluated usage data and the attribute data and provides an action to take in accordance with the selected rule.

In some embodiments, the action comprises, for at least some installed software, replacement of the software by alternative software.

In some embodiments the mapping rules provide different actions for respective computers.

Another aspect of the invention provides a computer implemented method comprising:
receiving, from a source of usage data, data relating to usage of software installed on respective computers of the system, and receiving, from a source of attribute data, data relating to attributes associated with the computers,
evaluating the usage of the installed software based on the usage data, and
selecting a mapping rule associated with the installed software in dependence on the evaluated usage data and the attribute data and providing an action to take in accordance with the selected rule.

In some embodiments, the action comprises, for at least some installed software, replacement of the software by alternative software.

In some embodiments the mapping rules provide different actions for respective computers.

Further features and advantages of the invention will become apparent from the following description of illustrative embodiments of the invention, given by way of example only, which is made with reference to the accompanying drawings.

### BRIEF DESCRIPTION OF THE DRAWINGS

FIG. 1 is a schematic block diagram of networked computer system incorporating an embodiment of the present invention;

FIG. 2 is a an illustration of an example of attributes;

FIG. 3 is a schematic illustration of a rules database;

FIG. 4 is a schematic block diagram operations carried out by an example of a usage processor of FIG. 1; and

FIG. 5 is a schematic block diagram of a computer of the network of FIG. 1.

### DETAILED DESCRIPTION

Overview

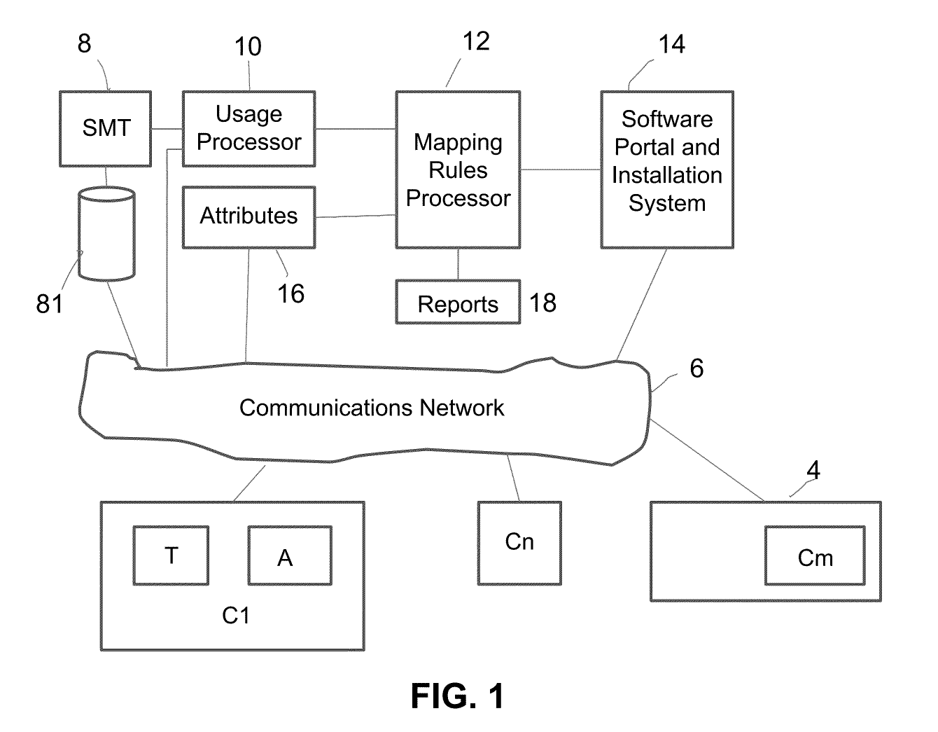

Referring to FIG. 1, a network comprises one or more computers C1, Cn at least some Cm of which may be organised in one or more subnets 4. The network may be a private network operated by a commercial company. The computers and subnets are linked by a communications network shown symbolically at 6.

The network further comprises a system management tool 8 for example a Configuration Manager (ConfigMgr) also formerly known as a Systems Management Server (SMS) provided by Microsoft Corporation. Other companies also provide systems management tools. The tool 8 has a data base 81 storing data relating to the configuration of the network. The tool 8 uses agents A on the computers 21 . . . 2n which report regularly to the tool 8. Each agent A on a computer C1, Cm . . . Cn identifies the software on the computer and the times of use of the software.

Linked to the systems management tool 8 is a usage processor 10. The usage processor 10 provides processed usage data to a mapping rules processor 12 which will be described in more detail below. The data produced by the mapping rules processor may be used to control the provision by a software portal 14 of software to the computers C1 . . . Cn of the network. The software portal 14 is a source of software which users can access to request the download of software which has for example been pre-approved by the relevant manager(s) of the commercial company who operate the network. The software portal 14 may provide a link to a source of the required software. In an example of the present invention, the mapping rules processor and the software portal act to automatically install on a computer C software chosen according to the mapping rules and to uninstall unused software and software which is replaced by new software.

In addition to the systems management tool monitoring software on the computers, the usage processor 10 may periodically determine whether the computers are active.

The mapping rules processor 12 determines what action to take or recommendation to make in relation to software installed on a computer. The action or recommendation depends on the role of the computer and the usage of the installed software. The result of applying the rules may be a report 18 and/or control of the software portal 14 to install software on a computer C and/or uninstall unused or replaced software. Installation and un-installation of software may be automatic or controlled by the user or a network administrator.

Attribute Data

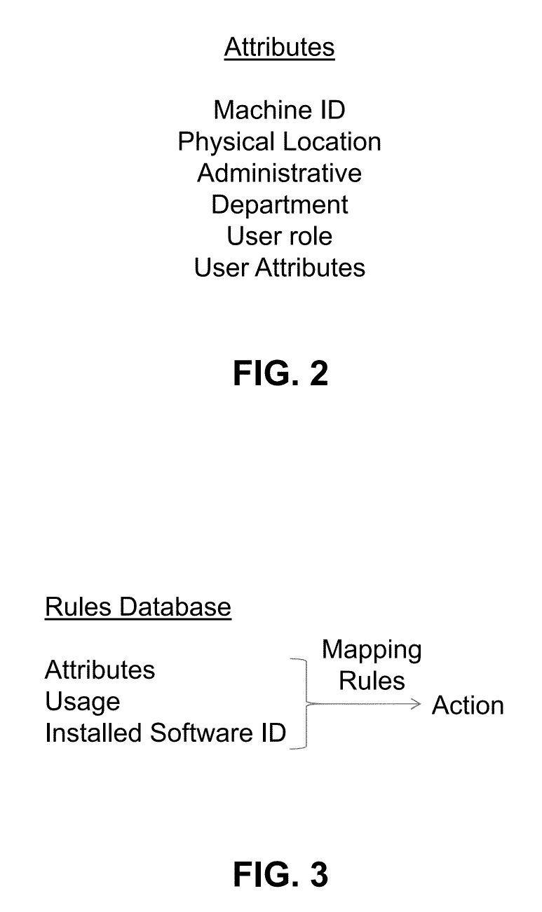

A source 16 of attribute data provides attribute data to the mapping rules processor 12. The attribute data may be derived from various sources. In this example it is derived from tags T which are data sets stored in the computers C. Referring to FIG. 2, the attribute data includes machine ID which is an identifier of the computer. The identifier is unique amongst the computers C of the network and may be globally unique. The attribute data further includes data identifying the role of the machine for example the department in which it is located and the role of the user: for example accounts department and accountant. The attribute data may include other information for example the physical location of the machine (for example Ealing, London) and/or data relating to attributes of the user for example Manager. In a network, plural computers with different roles are tagged with attribute data identifying their respective different roles. Several computers on the network may have the same role.

Some computers may not have tags of attribute data. The attributes of such computers may be found from other sources, for example asset registers.

Usage Data

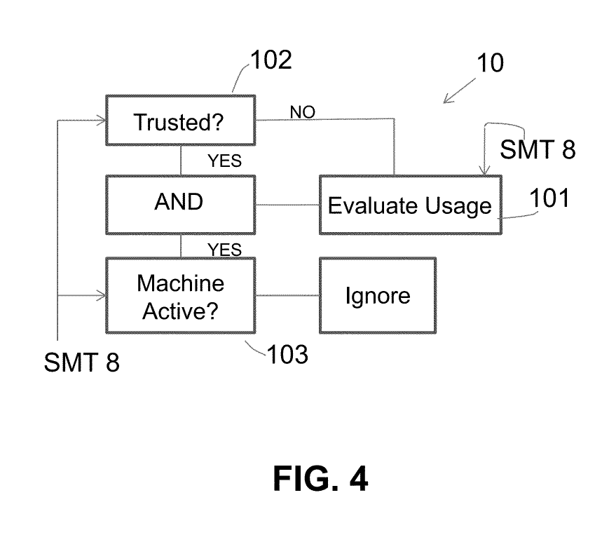

Referring to FIG. 4, usage of software on a computer is analysed into categories if the computer is both “trusted” and “active”. If the computer is not trusted all software on it is deemed to be used.

### DEFINITIONS

Various property names are used below and are indicated by italics. They have the following meanings:

| Property Name | Description |
|---|---|
| Removal | Assuming all other values have no effect upon usage |
| Possible Lower | evaluation, the boundary between an installation |
| Threshold | being considered used and rarely used. |
| Removal | Assuming all other values have no effect upon usage |
| Possible Upper | evaluation, the boundary between an installation |
| Threshold | being considered rarely used and unused. |
| Software | Assuming all other values have no effect upon a |
| Installation | machine's active status, the boundary between a |
| Inactivity | machine being considered active and inactive. |
| Threshold | |
| Usage Date | The boundary between a machine's usage data being |
| Inactivity | considered trusted and not trusted, assuming that other |
| Threshold | boundaries affecting activity have not been passed. |
| Device | The boundary between a machine being considered too |
| Maturity | new to be trusted and being mature enough to be |
| Threshold | trusted, regardless of other values. |
| Machine | The number of days after a machine is initially |
| Inactivity | identified as being inactive and considering it to |
| Timeout | be confirmed as inactive and excluded from future |
| | installation/usage calculations; assuming no new |
| | information overrules the initial inactivity |
| | identification. |

Illustrative default values for various properties are as follows:

| Property Name | Default Value (Days) |
|---|---|
| Removal Possible Lower Threshold | 31 |
| Removal Possible Upper Threshold | 89 |
| Software Installation Inactivity | 90 |
| Threshold | |
| Usage Data Inactivity Threshold | 30 |
| Device Maturity Threshold | 90 |
| Machine Inactivity Timeout | 7 |

It will be appreciated that other values may be chosen for the properties: the values are a design choice. The actual data with which the property thresholds and timeout are compared are derived from the systems management tool, e.g. ConfigMgr.

| Property Name | Description |
|---|---|
| ConfigMgr Creation Date | The machine's creation date as defined by |
| | the source ConfigMgr database 81. |
| Maximum Install Date | The most recent installation date for any |
| | product on the machine. |
| Maximum Usage Date | The most recent usage date for any product |
| | on the machine. |
| Machine Inactivity Date | The date at which the usage processor 10 |
| | identified the machine as no longer active. |
| Reference Date | The last date that software usage data for |
| | the machine was received. |
| Last Hardware Scan Date | The last hardware scan date as defined by |
| | the source ConfigMgr database 81. |

Trusted

A computer is trusted if ALL the following are true:
it reports a usage date for any software on that machine;
the machine creation date is older than the device maturity threshold; and
the computer's last hardware scan date is less than the usage data inactivity threshold.

Machine Active

A machine is deemed active if it is not inactive. A machine is inactive if ALL the following are true:
the machine's creation date is older than the device maturity threshold;
the machine's creation date is older than the software installation inactivity threshold;
the machine's max install date is older than the software installation inactivity threshold;
the machine's max usage date is older than the software installation inactivity threshold; and
the machine's last hardware scan date is older than the software installation inactivity threshold;
OR
the machine has been marked as decommissioned or obsolete in the database 81 of the system management tool 8 (e.g. ConfigMgr).

Normal Usage Calculation

If a machine is considered to be both “Active” and “Trusted” then usage calculation for a particular product for normal installations is based on an evaluation of the Reference date, the install date and last run date for the particular product as shown in the following table, Table 1. In the table “NULL” denotes that data is unavailable or incomplete. For example the install date or the last run date are not known.

TABLE 1

| | | <= Removal | | >= Removal | |
|---|---|---|---|---|---|
| | | Possible Lower | Between | Possible Upper | |
| REFERENCE DATE − INSTALL DATE | | Threshold | Thresholds | Threshold | NULL |
| REFERENCE | <= Removal Possible | USED | USED | USED | USED |
| DATE − LAST | Lower Threshold | | | | |
| RUN DATE | Between Thresholds | USED | RARELY | RARELY | RARELY |
| | | | | USED | USED |
| | > Removal Possible | USED | RARELY | UNUSED | UNUSED |
| | Upper Threshold | | USED | | |
| | NULL | USED | RARELY | UNUSED | USED |
| | | | USED | | |

If a machine reports a future date (this does sometimes occur with ConfigMgr) then it will fall into the “used” category as the following will be true:

Reference Date—“future” Date<Removal Possible Lower Threshold

Suite Usage Calculation

Some software products are identified as suites and the overall usage for the suite is calculated based on the most recent last run date for any component.

Sub-Components of a Package

Whilst this description refers mainly to software packages and suites of packages, it will be appreciated that the use of subcomponents of a package may be monitored and software evaluated on the basis of usage and non-usage of the sub-components (together with the relevant attribute data) as indicated in Example 2 below.

Reports

The mapping may be used to produce a report. The application of the rule(s) based on usage and attributes, may be a report recommending actions to take in relation to software installed on a computer. The report may be used by a licensing manager to determine what new licenses to buy (and what licenses to cancel) when planning an upgrade of the computer before an upgrade takes place. The application of the rule(s) based on usage and attributes may be a report simply of the role and usage of software installed on the computers of the network.

Usage in Reports

For products identified as suites the overall usage for the suite is calculated based on the per-component installations and usage. This then allows recommendations to be made in a report regarding whether a suite can be downgraded or completely removed based on the number of components installed and their usage.

Mapping Rules

Referring to FIG. 3, the mapping rules database relates the identity of installed software, attributes of the computer on which it is installed and the processed usage data to actions and/or recommendations. The mapping rules evaluate a particular software product installed in a particular computer on the basis of the usage as set out in Table 1 above and the attributes of the computer in which it is installed. The mapping is stored in a database and a particular mapping is addressed by a combination of the usage data of Table 1 and the attribute data.

Actions may include without limitation: do nothing; replace a particular product with another product in dependence on attribute data regardless of use; replace a particular product with another product in dependence on attribute data and use; uninstall a product in dependence on use and attribute data.

Different rules may be established for different attributes. Different rules may be established for different software products. Different rules may be established for different computers as identified by the attribute data.

### EXAMPLES

Examples of applying the rules process include (without limitation):
1) A computer in the development department has a software development tool.

Whether or not that tool has been used the recommendation and/or the action taken is to upgrade the tool to the most recent version. More generally, for any computer having software which is important to the role of the department, the recommendation and/or action to take is to upgrade the software regardless of use.
2) A computer in an administration department has Adobe Acrobat but it is used only to read pdf documents so the recommendation and/or action is to replace it with a pdf reader because that is all that is required for that role. More generally, some software may be downgraded on the basis of features used, dependent on the attributes associated with the computer.
3) A computer in a graphics design department has Adobe Photoshop 5 installed. If it is used it is upgraded to Adobe Photoshop CS6. If it is rarely used it is replaced by PAINT.net. If it is unused it is uninstalled.

New Operating System

A rule or a set of rules may also depend on whether or not a new operating system is being installed either to replace an existing operating system or to provide a new bare metal machine joining a subnet. Operating systems may be provided to computers Cn in subnets using 1E's product PXELite.

Based on usage of software used with the old operating system and the attributes associated with the computer, when a new operating system is provided, new software compatible with the new operating system is chosen. As exemplified above, some software may be upgraded to be compatible with the new operating system regardless of use because of the attributes, whilst other software may be replaced by an alternative or not replaced, on the basis of use and attributes.

AppClarity

1E Limited provides a software product AppClarity™. An embodiment of the present invention may be used with AppClarity™. One of the functions of AppClarity™ is to standardise the identifiers of software packages because it has been observed that what are in fact identical packages may have for various reasons variations in their identifiers. AppClarity™ thus reduces the number of apparently different software packages and provides consistent identification of software packages for use by the software portal 14 the rules processor 12 and the usage processor. A usage processing engine 10 may be implemented within AppClarity™.

Computer Programs

The invention also provides a computer program which when run on a computer Cn implements the procedures described above. The computer program is stored on a non transitory carrier, for a computer readable medium for example a hard disk, an optical disc, a magneto-optical disk, a compact disc, a magnetic tape, electronic memory including Flash memory, ROM and RAM, a RAID or any other suitable computer readable storage device.

A Computer

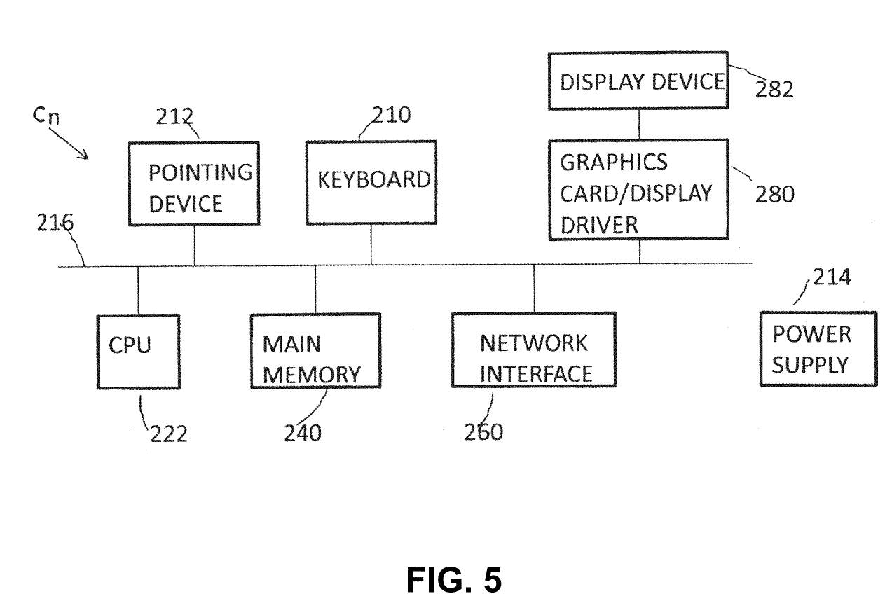

Referring to FIG. 5, an illustrative one of the computers 2n comprises, amongst other items: a CPU 222; a main memory 240 for example a hard disk drive or other storage device, for example electronic memory; a network interface 260; a display driver 280 coupled to a display device 282; human interface devices or input devices for example a keyboard 210 and a pointing device 212; and one or more busses 216; The items are conventional and interact via the buss(es) in a conventional way. The network interface couples the computer to other computers C1 to Cm having respective IP (Internet Protocol) addresses. The computer also comprises a power supply 214. Programs are stored in the main memory 240 and executed by the CPU 222.

The usage processor and the mapping rules processor may be provided by a usage evaluation engine running on a processor and a rules engine running on another processor or both may be run on the same processor. Such processors are generally similar to the computer of FIG. 5. The attributes data 16 may be stored in the main memory 240 of the computer. Likewise usage data may be stored in the main memory for processing and the evaluated usage data may be stored in the main memory for supply to the rules engine.

The above embodiments are to be understood as illustrative examples of the invention. Further embodiments of the invention are envisaged. For example, whilst the computers have agents installed on them to monitor usage and report to the systems management tool, usage can be determined in other ways for example monitoring traffic on the network. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A networked computer system, comprising:
a source of usage data relating to usage of software installed on respective computers of the system;
a source of attribute data relating to attributes associated with the computers;
a usage engine which evaluates usage of the installed software based on the usage data; and
a mapping engine arranged to select a mapping rule associated with the installed software in dependence on the evaluated usage data and the attribute data and to provide an action to take in accordance with the selected rule,
wherein the action comprises, for at least some installed software, replacement of the software by alternative software.

2. A system according to claim 1, wherein the attribute data of a computer comprises data identifying the computer and one or more of the physical location of computer, and the role of the computer.

3. A system according to claim 2, wherein the data identifying the role of the computer includes one or more of data identifying the role of the user and the role of the administrative unit to which the computer is allocated in an enterprise.

4. A system according to claim 2, wherein the attribute data further includes data relating to the user.

5. A system according to claim 1, wherein the usage engine is arranged to evaluate whether a computer of the system is active before evaluating the usage data associated with the computer.

6. A system according to claim 5, wherein the usage engine is arranged to evaluate the reliability of data relating to a computer of the system before evaluating the usage data associated with the computer.

7. A system according to claim 1, wherein the usage engine is arranged to evaluate usage on the basis of a comparison of one or more usage measures with respective ones of one or more thresholds.

8. A system according to claim 1, wherein the usage engine is arranged to evaluate usage on the basis of a combination of comparisons of a measure dependent on the installation date of software with thresholds and comparisons of a measure dependent on the most recent detected run date of the software with thresholds.

9. A system according to claim 1, wherein the mapping engine comprises a database of mapping rules addressable by the evaluated usage data and the attribute data to select a particular mapping rule.

10. A system according to claim 9, wherein the mapping engine include a rule which selects in dependence on the attribute and usage data, for a particular item of software, one of an upgrade of the same software, replacement of the item by alternative software of similar or less function, and un-installation of the software.

11. A system according to claim 9, wherein the mapping engine include a rule which selects dependent on the attribute data, for a particular item of software, upgrade of item regardless of use.

12. A system according to claim 1, wherein the usage data provides measures of the usage of sub-components of items of software and the mapping engine include a rule which selects in dependence on the attribute and usage data, for a particular item of software having sub-components, alternative software providing the functionality of the one or more sub-components for which usage exceeds a threshold value.

13. A system according to claim 1, further comprising an installation engine arranged to automatically replace an item of software on a said computer with alternative software in accordance with the said action.

14. A non-transitory computer readable medium storing instructions which, when executed by a processor arranged to receive, from a source of usage data, data relating to usage of software installed on respective computers of the system, and to receive, from a source of attribute data, data relating to attributes associated with the computers, causes the processor to perform a computer implemented method comprising:
evaluating usage of the installed software based on the usage data; and
selecting a mapping rule associated with the installed software in dependence on the evaluated usage data and the attribute data and provides an action to take in accordance with the selected rule,
wherein the action comprises, for at least some installed software, replacement of the software by alternative software.

15. A computer implemented method, comprising:
receiving, from a source of usage data, data relating to usage of software installed on respective computers of the system, and receiving, from a source of attribute data, data relating to attributes associated with the computers;
evaluating the usage of the installed software based on the usage data;
selecting a mapping rule associated with the installed software in dependence on the evaluated usage data and the attribute data; and
providing an action to take in accordance with the selected rule,
wherein the action comprises, for at least some installed software, replacement of the software by alternative software.

16. A networked computer system, comprising:
a source of usage data relating to usage of software installed on respective computers of the system;
a source of attribute data relating to attributes associated with the computers;
a usage engine which evaluates usage of the installed software based on the usage data; and
a mapping engine arranged to select a mapping rule associated with the installed software in dependence on the evaluated usage data and the attribute data and to provide an action to take in accordance with the selected rule,
wherein the mapping engine provides mapping rules which provide different actions for respective computers.

17. A non-transitory computer readable medium storing instructions which, when executed by a processor arranged to receive, from a source of usage data, data relating to usage of software installed on respective computers of the system, and to receive, from a source of attribute data, data relating to attributes associated with the computers, causes the processor to perform a computer implemented method comprising:
evaluating usage of the installed software based on the usage data; and
selecting a mapping rule associated with the installed software in dependence on the evaluated usage data and the attribute data and provides an action to take in accordance with the selected rule,
wherein the mapping rules provide different actions for respective computers.

18. A computer implemented method, comprising:
receiving, from a source of usage data, data relating to usage of software installed on respective computers of the system, and receiving, from a source of attribute data, data relating to attributes associated with the computers;
evaluating the usage of the installed software based on the usage data;
selecting a mapping rule associated with the installed software in dependence on the evaluated usage data and the attribute data; and
providing an action to take in accordance with the selected rule,
wherein the mapping rules provide different actions for respective computers.
